(19) United States
(12) Patent Application Publication
(10) Pub. No.: US 2025/0046085 A1
(43) Pub. Date: Feb. 6, 2025

(54) METHOD AND SYSTEM FOR ANALYTICS SELECTION BASED ON PURSUIT-CONTEXT DETAILS

(71) Applicant: Motorola Solutions, Inc., Chicago, IL (US)

(72) Inventors: JIN HOE PHUA, BAYAN LEPAS (MY); ZHE QIAN GOH, SIMPANG AMPAT (MY); DAL DALILA BINTI BHA'ARI, BUKIT MERTAJAM (MY); BOON HAUR OUN, BAYAN LEPAS (MY); EU JIN ONG, GEORGETOWN (MY)

(21) Appl. No.: 18/365,251

(22) Filed: Aug. 4, 2023

(51) Int. Cl. G06V 20/52; G06T 7/20; G06V 10/74; G06V 40/20; H04N 21/2187

(52) U.S. Cl. CPC G06V 20/52; G06T 7/20; G06V 10/761; G06V 40/20; G08B 5/226; H04N 21/2187

(57) ABSTRACT

A method and system for analytics selection based on pursuit-context details is disclosed. The method includes tracking a pursuer object and a pursued object, and using analytics on video or image data corresponding to the pursuer object and/or the pursued object to determine at least one pursuit-context detail. The pursuit-context detail(s) are matched to a select one of a plurality of object behavior-targeted analytics.

### BACKGROUND

During a suspect pursuit, information communication that is timely and intuitive can positively impact the correct tracking of the suspect's location, potentially preventing an ambush attack. In systems where real-time information and images can be obtained from network-addressable security cameras, so-called object tracking may be of assistance in the context of the suspect pursuit. In this context, it is understood that the suspect/person can be a type of trackable “object”.

Object tracking refers to the use of computer vision for following a specific object or multiple objects of interest in a given scene, and where camera coverage of the scene may or may not be spread across a plurality of cameras. Object tracking has traditionally been used in, for example, security video processing. Object tracking in security video processing may include making observations following an initial object detection.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with example embodiments.

FIG. 2 is a flow chart illustrating a computer-implemented method in accordance with an example embodiment.

FIG. 3 is a diagram illustrating an example pursuit path, video-camera covered by a number of fixed-location cameras, and the fixed-location cameras forming a part of a security system which may be configured to operate in accordance with the example embodiment of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a computer-implemented method that includes tracking, using an least one processor, a pursuer object and a pursued object. The pursuer object is engaged in movement consistent with potentially entering a Field Of View (FOV) of at least one fixed-location camera at a future point in time. The computer-implemented method also includes using analytics on first video or image data corresponding to at least one of the pursuer object and the pursued object to determine at least one pursuit-context detail. The computer-implemented method also includes matching, using the at least one processor, the at least one pursuit-context detail to a select one of a plurality of object behavior-targeted analytics. After the one of the plurality of object behavior-targeted analytics is selected, the one of the plurality of object behavior-targeted analytics is actuated to act on second video or image data captured by the at least one fixed-location camera in generating information relevant to a potential pursuer confrontation or apprehension in relation to the pursued object. The computer-implemented method also includes making the generated information electronically accessible to a mobile electronic device prior to the potential pursuer confrontation or apprehension.

In accordance with another example embodiment, there is provided a system that includes an at least one processor and an at least one fixed-location camera configured to capture video or image data. The system also includes an at least one electronic storage medium storing program instructions that when executed by the at least one processor cause the at least one processor to perform tracking a pursuer object and a pursued object. The pursuer object is engaged in movement consistent with potentially entering an FOV of the at least one fixed-location camera at a future point in time. The program instructions upon execution by the at least one processor also cause the at least one processor to perform analyzing additional video or image data corresponding to at least one of the pursuer object and the pursued object to determine at least one pursuit-context detail. The program instructions upon execution by the at least one processor also cause the at least one processor to perform matching the at least one pursuit-context detail to a select one of a plurality of object behavior-targeted analytics. After the one of the plurality of object behavior-targeted analytics is selected, the one of the plurality of object behavior-targeted analytics is actuated to act on the video or image data captured by the at least one fixed-location camera in generating information relevant to a potential pursuer confrontation or apprehension in relation to the pursued object. The program instructions upon execution by the at least one processor also cause the at least one processor to make the generated information electronically accessible to a mobile electronic device prior to the potential pursuer confrontation or apprehension.

Each of the above-mentioned embodiments will be discussed in more detail below, starting with example system and device architectures of the system in which the embodiments may be practiced, followed by an illustration of processing blocks for achieving an improved technical method, device, and system for analytics selection based on pursuit-context details.

Example embodiments are herein described with reference to flowchart illustrations and/or block diagrams of methods, apparatus (systems) and computer program products according to example embodiments. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

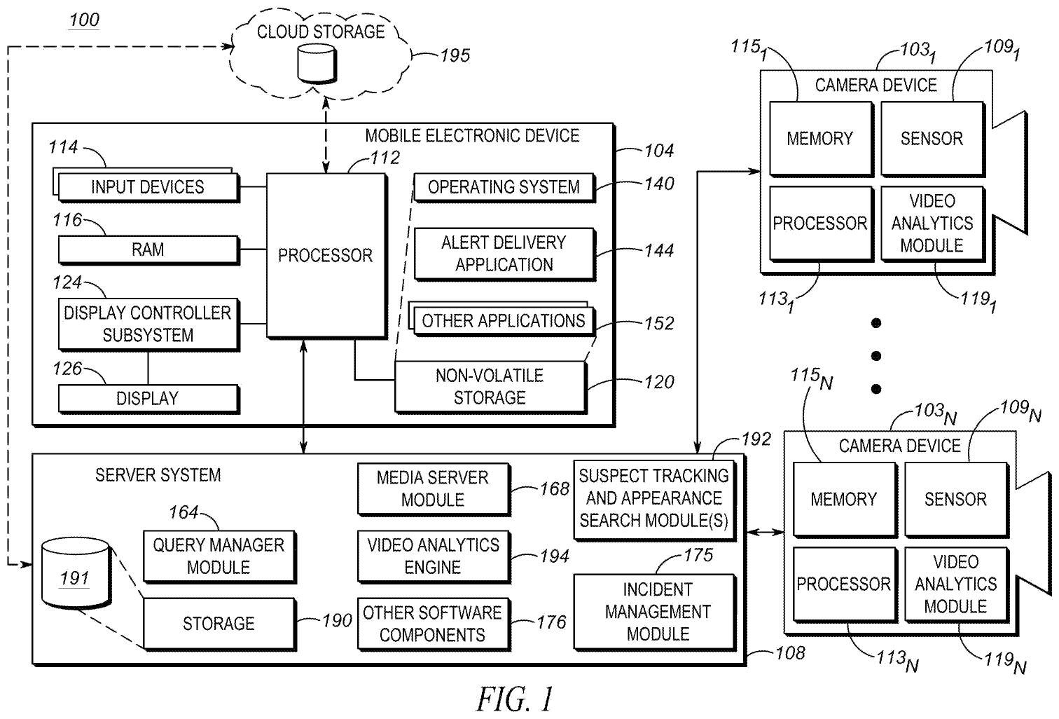

Referring now to the drawings, and in particular FIG. 1 which is a block diagram of an example system 100 within which methods in accordance with example embodiments can be carried out. Included within the illustrated system 100 are one or more mobile electronic devices 104 and a server system 108. In some example embodiments, the mobile electronic device 104 is a handheld device such as, for example, a tablet, a phablet, a two-way radio, a smart phone or a personal digital assistant (PDA); a laptop computer; a smart television; and other suitable devices. With respect to the server system 108, this could comprise a single physical machine or multiple physical machines. It will be understood that the server system 108 need not be contained within a single chassis, nor necessarily will there be a single location for the server system 108. As will be appreciated by those skilled in the art, at least some of the functionality of the server system 108 can be implemented within the mobile electronic device 104 rather than within the server system 108.

The mobile electronic device 104 communicates with the server system 108 through one or more networks. These networks can include the Internet, or one or more other public/private networks coupled together by network switches or other communication elements. As an example and not by way of limitation, the mobile electronic device 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the mobile electronic device 104 may be capable of communicating with a Wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these.

The mobile electronic device 104 includes at least one processor 112 that controls the overall operation of the mobile electronic device. The processor 112 interacts with various subsystems such as, for example, input devices 114 (such as a selected one or more of a keyboard, mouse, scanner, touch pad, roller ball and voice control means, for example), random access memory (RAM) 116, non-volatile storage 120, display controller subsystem 124 and other subsystems. The display controller subsystem 124 interacts with display screen 126 and it renders graphics and/or text upon the display screen 126.

Still with reference to the mobile electronic device 104 of the system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the mobile electronic device 104 is turned off. Regarding the operating system 140, this includes software that manages computer hardware and software resources of the mobile electronic device 104 and provides common services for computer programs. Also, those skilled in the art will appreciate that the operating system 140, alert delivery application 144, and other applications 152, or parts thereof, may be temporarily loaded into a volatile store such as the RAM 116. The processor 112, in addition to its operating system functions, can enable execution of the various software applications on the mobile electronic device 104.

Regarding the alert delivery application 144, this can be run on the mobile electronic device 104 and may include various application components such as, for example, a User Interface (UI) module. The UI module may be cooperatively coupled with a search session manager module in order to enable a mobile device user to carry out actions related to providing input in relation images, live video and video recordings (such as, for example, input to facilitate carrying out, suspect tracking, one or more appearance searches, etcetera). Also, regarding the aforementioned search session manager module, this provides a communications interface between the search UI module and a query manager module 164 of the server system 108. In at least some examples, the search session manager module communicates with the query manager module 164 through the use of Remote Procedure Calls (RPCs). The query manager module 164 receives and processes queries originating from the mobile electronic device 104, which may facilitate retrieval and delivery of specifically defined video (and respective metadata) in support of, for example, client-side video review, video export, managing event detection, suspect tracking, etc. In this regard, the query manager module 164 is communicatively coupled to one or more data stores 190 (described later herein in more detail) and at least one suspect tracking and appearance search module 192 that supports the applicable video searches.

Still with reference to FIG. 1, the server system 108 includes several software components (besides the query manager module 164 already described) for carrying out other functions of the server system 108. For example, the server system 108 includes a media server module 168. The media server module 168 handles client requests related to storage and retrieval of security video taken by camera devices 103₁-103ₙ in the system 100. The server system 108 also includes a video analytics engine 194. The video analytics engine 194 can, in some examples, be any suitable one of known commercially available software that carry out computer vision related functions (complementary to any video analytics performed in the security cameras) as understood by a person of skill in the art. Other suitable implementation alternatives, apparent to those skilled in the art, are also contemplated.

The server system 108 also includes an incident management module 175 which may facilitate, for example, management of active crime investigations, management of police officer reports and requests, evidence gathering, etc. The server system 108 also includes a number of other software components 176. These other software components will vary depending on the requirements of the server system 108 within the overall system. As one example, the other software components 176 might include special test and debugging software, or software to facilitate version updating of modules within the server system 108.

Regarding the data store 190, this comprises, for example, one or more databases 191 which may facilitate the organized storing of recorded security video, other sensor data, etc. in accordance with example embodiments. The one or more databases 191 may also contain metadata related to, for example, the recorded security video that is storable within the one or more data stores 190. Examples of metadata that may be expected to be derived directly or indirectly from video data include location in field of view, object ID, bounding box-related data, tracking position relative to field of view, etc. The one or more databases 191 may also contain records and data relevant to the incident management module 175.

Optionally, the system 100 may include connections to the illustrated one or more cloud services 195. For example, the mobile electronic device 104 may be connected to the cloud service(s) 195 by the Internet and/or one or more wireless and/or wired wide area networks (examples of which were previously herein detailed). Similarly, the server system 108 may be connected to the cloud service(s) 195 by the Internet and/or one or more wireless and/or wired wide area networks (examples of which were previously herein detailed). The cloud service(s) 195 which may, amongst other things, include neural network(s), and may include functionality similar and/or complementary to functionality provided by the server system 108. In some examples, the cloud service(s) 195 may support multi-site suspect tracking and/or appearance searching where the cloud service(s) 195 is communicatively coupled to a plurality of the server systems 108 to run coordinated searching across a plurality of security camera sites each with their respective server system 108.

The illustrated system 100 includes a plurality of camera devices 103₁-103ₙ (hereinafter interchangeably referred to as “cameras 103₁-103ₙ” when referring to all of the illustrated cameras, or “camera 103” when referring to any individual one of the plurality) being operable to capture a plurality of images and produce image data representing the plurality of captured images. The camera 103 is an image capturing device and includes security video cameras. Furthermore, it will be understood that the system 100 includes any suitable number of cameras (i.e. n is any suitable integer greater than one).

The camera 103 includes an image sensor 109 (corresponding to one of the sensors 109₁-109_{N} shown in FIG. 1) for capturing a plurality of images. The camera 103 may be a digital video camera and the image sensor 109 may output captured light as a digital data. For example, the image sensor 109 may be a CMOS, NMOS, or CCD. In some embodiments, the camera 103 may be an analog camera connected to an encoder. The illustrated camera 103 may be a 2D camera; however use of a structured light 3D camera, a time-of-flight 3D camera, a 3D Light Detection and Ranging (LiDAR) device, a stereo camera, or any other suitable type of camera within the system 100 is contemplated.

The image sensor 109 may be operable to capture light in one or more frequency ranges. For example, the image sensor 109 may be operable to capture light in a range that substantially corresponds to the visible light frequency range. In other examples, the image sensor 109 may be operable to capture light outside the visible light range, such as in the infrared (IR) and/or ultraviolet range. In other examples, the camera 103 may be a “multi-sensor” type of camera, such that the camera 103 includes pairs of two or more sensors that are operable to capture light in different and/or same frequency ranges.

The camera 103 may be a dedicated camera. It will be understood that a dedicated camera herein refers to a camera whose principal features is to capture images or video. In some example embodiments, the dedicated camera may perform functions associated with the captured images or video, such as but not limited to processing the image data produced by it or by another camera. For example, the dedicated camera may be a security camera, such as any one of a Pan-Tilt-Zoom (PTZ) camera, dome camera, in-ceiling camera, box camera, and bullet camera.

Additionally, or alternatively, the camera 103 may include an embedded camera. It will be understood that an embedded camera herein refers to a camera that is embedded within a device that is operational to perform functions that are unrelated to the captured image or video. For example, the embedded camera may be a camera found on any one of a drone device, a vehicle, a security panel, etc.

The camera 103 includes one or more processors 113 (corresponding to one of the processors 113₁-113_{N} shown in FIG. 1), one or more video analytics modules 119 (corresponding to one of the video analytics modules 119₁-119_{N} shown in FIG. 1), and one or more memory devices 115 (corresponding to one of the memories 115₁-115_{N} shown in FIG. 1) coupled to the processors and one or more network interfaces. Regarding the video analytics module 119, this generates metadata outputted to the server system 108. The metadata can include, for example, records which describe various detections of objects such as, for instance, pixel locations for the detected object in respect of a first record and a last record for the camera within which the respective metadata is being generated.

Regarding the memory device 115, this can include a local memory (such as, for example, a RAM and a cache memory) employed during execution of program instructions. Regarding the processor 113, this executes computer program instructions (such as, for example, an operating system and/or software programs), which can be stored in the memory device 115.

In various embodiments the processor 113 may be implemented by any suitable processing circuit having one or more circuit units, including a digital signal processor (DSP), graphics processing unit (GPU) embedded processor, a visual processing unit or a vison processing unit (both referred to herein as “VPU”), etc., and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example. A system on a chip (SOC) implementation is also common, where a plurality of the components of the camera 103, including the processor 113, may be combined together on one semiconductor chip. For example, the processor 113, the memory device 115 and the network interface of the camera 103 may be implemented within a SOC. Furthermore, when implemented in this way, a general purpose processor and one or more of a GPU or VPU, and a DSP may be implemented together within the SOC.

In various example embodiments, the memory device 115 coupled to the processor 113 is operable to store data and computer program instructions. The memory device 115 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device 115 may be operable to store memory as volatile memory, non-volatile memory, dynamic memory, etc. or any combination thereof.

Continuing with FIG. 1, the camera 103 is coupled to the server system 108. In some examples, the camera 103 is coupled to the server system 108 via one or more suitable networks. These networks can include the Internet, or one or more other public/private networks coupled together by network switches or other communication elements. The network(s) could be of the form of, for example, client-server networks, peer-to-peer networks, etc. Data connections between the camera 103 and the server system 108 can be any number of known arrangements, examples of which were previously herein detailed. In at least one example embodiment, the camera 103 and the server system 108 are within the same Local Area Network (LAN). In some examples, the camera 103 may be coupled to the server system 108 in a more direct manner than as described above.

Although the system 100 illustrated in FIG. 1 only explicitly shows video sensor devices coupled to the server system 108, it will be understood that the system 100 is not limited in contemplated compositions to just video sensor devices. Some examples of the system 100 include a heterogeneous mixture of both video sensor devices and non-video sensor devices (for example, radar-based devices) coupled to the server system 108.

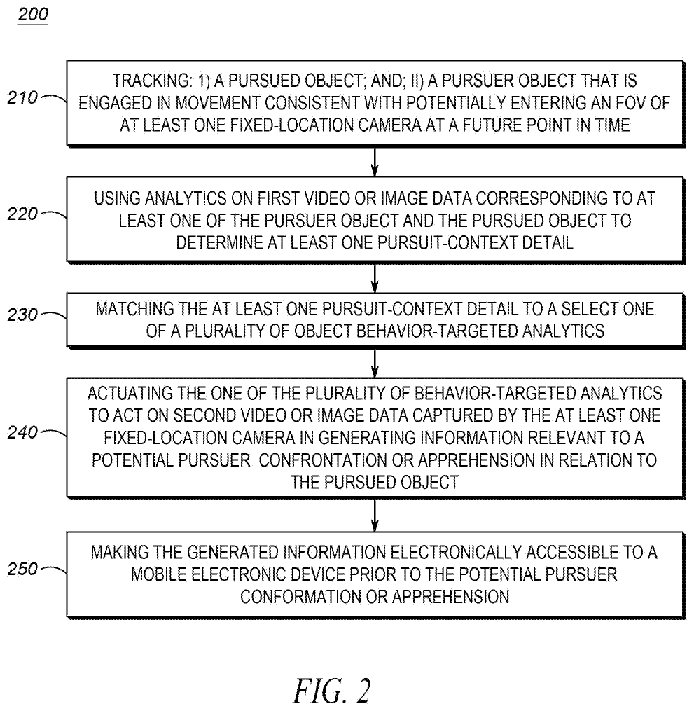

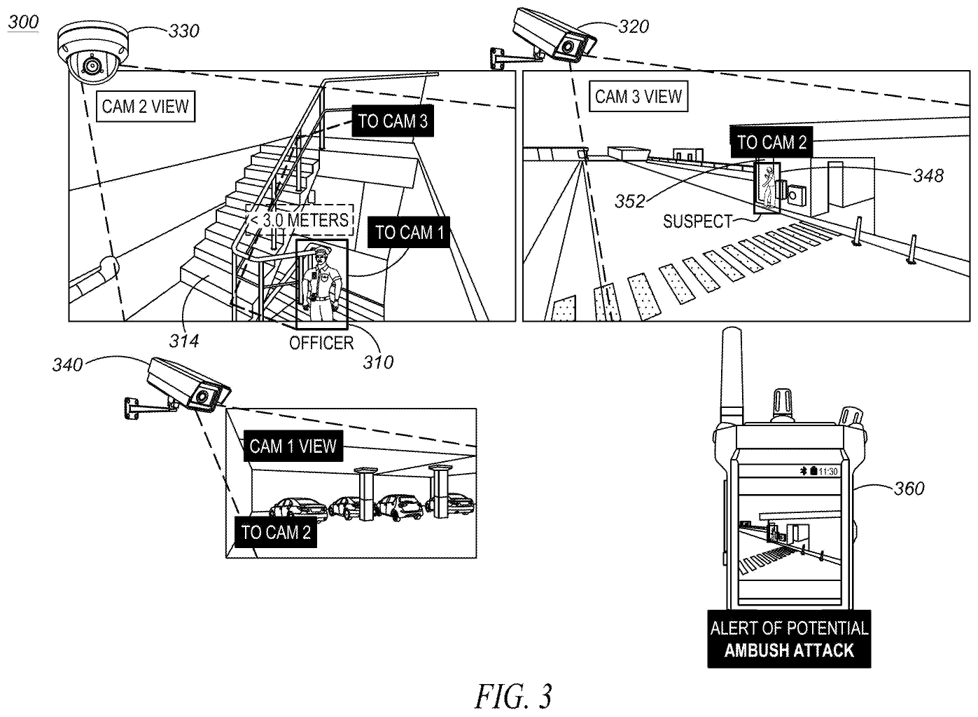

Reference is made to FIGS. 2 and 3. FIG. 2 is a flow chart illustrating a method 200 in accordance with an example embodiment. FIG. 3 is a diagram illustrating an example pursuit path 300, video-camera covered by a number of fixed-location cameras forming a part of a security camera system which may be configured to operate in accordance with the example embodiment of FIG. 2.

Firstly, with reference to the method 200 of FIG. 2, a pursuer object and a pursued object are tracked (210). During a period of this tracking, the pursuer object is engaged in movement consistent with potentially entering a Field Of View (FOV) of at least one fixed-location camera at a future point in time. For example, in FIG. 3, police officer 310 (pursuer object) is moving up a flight of stairs 314, which is consistent with eventually entering, at a future point in time, the FOV of camera 320 (each of illustrated cameras 320, 330 and 340 may be, for example, the same or similar to the camera 103 shown in FIG. 1). In at least one example, video analytics (for instance, action of the video analytics engine 194 of FIG. 1 or video analytics module 119 of FIG. 1) generates a notification of the pursuer object leaving the FOV of the camera 330 when the pursuer object moves into a defined exit region of the FOV of the camera 330. Based on this notification, a mobile electronics device carried by the police officer 310 (or some other person) may begin automatically displaying live video captured by the camera 320.

Other pursuit-relevant actions carried out by the video analytics besides the above-described notification action are contemplated. For example, the video analytics may determine a change in mobility potential of the pursued object (for instance, detect when the pursued object starts limping, the pursued object acquires a motorcycle, etcetera). As another example, the video analytics may determine, based on a change in a behavior of the pursued object, a change in: i) threat level to the pursuer object, or ii) a change in expected visibility of the pursued object. It is also contemplated that alerts or notifications may be generated by any of these above determinations made from the video analytics. In one or more of these examples, altering/notifying may be facilitated by action of the alert delivery application 144 of FIG. 1.

Next in the method 200, using analytics on first video or image data corresponding to at least one of the pursuer object and the pursued object, at least one pursuit-context detail is determined (220). For example, in FIG. 3, pursuit-context details include that a suspected perpetrator of an offence (suspect) 348 is at a front position in the pursuit by the police officer 310 against him, and that the suspect 348 is on the roof of the parkade, spatially-located above the police officer 310, and additionally the suspect 348 is hovered adjacent a door 352, which is an exit point for someone who has just climbed the flight of stairs 314.

Next in the method 200, the at least one pursuit-context detail is matched (230) to a select one of a plurality of object behavior-targeted analytics. For example, in FIG. 3, the pursuit-context details that correspond to the pursuit by the police officer 310 may be matched to, for instance, the following object behavior-targeted analytics: ambush detection.

Next in the method 200, after the one of the plurality of object behavior-targeted analytics is selected, the one of the plurality of object behavior-targeted analytics is actuated (240) to act on second video or image data captured by the at least one fixed-location camera in generating information relevant to a potential pursuer confrontation or apprehension in relation to the pursued object. For example, in FIG. 3, an ambush detection alert may be triggered based on images showing that the suspect 348 is hovered adjacent a door 352, which is an exit point for someone who has just climbed the flight of stairs 314.

Next in the method 200, the generated information is made electronically accessible (250) to a mobile electronic device prior to the potential pursuer confrontation or apprehension. For example, as shown in FIG. 3, the above-described alert is automatically generated and displayed on screen of a two-way radio 360 (which, in some examples, is consistently similar to the mobile electronic device 104 in FIG. 1, which includes the alert delivery application 144). In the illustrated example, this alert is visible; however in alternative examples the alert may be audible (e.g. since the two-way radio 360 will include a speaker), or both audible and visible.

Other examples of alerts besides ambush alerts are contemplated. For example, following distance alerts are contemplated (such as, for instance, alerting in response to detecting that a following distance, determined based on a geographic-following separation of the pursued object relative to the pursuer object, has dropped below an alert-triggering threshold). As another example, approaching distance alerts are contemplated (such as, for instance, alerting in response to detecting that an approaching distance, determined based on a geographic-approaching separation of the pursuer object relative to the pursued object, has dropped below an alert-triggering threshold).

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot match a pursuit-context detail to a select one of a plurality of object behavior-targeted analytics, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server (this contemplated “partly”/“entirely” possibility is consistent with, for example, the one or more cloud services 195 shown in FIG. 1). In the latter scenario, the remote computer or server may include cloud or other storage, and may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
tracking, using an least one processor, a pursuer object and a pursued object, wherein the pursuer object is engaged in movement consistent with potentially entering a Field Of View (FOV) of at least one fixed-location camera at a future point in time;
using analytics on first video or image data corresponding to at least one of the pursuer object and the pursued object to determine at least one pursuit-context detail;
matching, using the at least one processor, the at least one pursuit-context detail to a select one of a plurality of object behavior-targeted analytics;
after the one of the plurality of object behavior-targeted analytics is selected, actuating the one of the plurality of object behavior-targeted analytics to act on second video or image data captured by the at least one fixed-location camera in generating information relevant to a potential pursuer confrontation or apprehension in relation to the pursued object; and
making the generated information electronically accessible to a mobile electronic device prior to the potential pursuer confrontation or apprehension.

2. The computer-implemented method of claim 1 wherein the pursuer object is a police officer and the pursued object is a suspected perpetrator of an offence.

3. The computer-implemented method of claim 1 further comprising automatically generating an audibly or visibly perceivable alert on the mobile electronic device.

4. The computer-implemented method of claim 3 wherein the generating of the audibly or visibly perceivable alert is in response to detecting that a following distance, determined based on a geographic-following separation of the pursued object relative to the pursuer object, has dropped below an alert-triggering threshold.

5. The computer-implemented method of claim 3 wherein the generating of the audibly or visibly perceivable alert is in response to detecting that an approaching distance, determined based on a geographic-approaching separation of the pursuer object relative to the pursued object, has dropped below an alert-triggering threshold.

6. The computer-implemented method of claim 1 wherein:
the first video or image data is video data captured from another fixed-location camera, and
the analytics is configured to generate a notification of the pursuer object leaving an FOV of the another fixed-location camera when the pursuer object moves into a defined exit region of the FOV of the another fixed-location camera.

7. The computer-implemented method of claim 6 further comprising automatically displaying, on a screen of the mobile electronic device and based on the notification, live video captured by the at least one fixed-location camera.

8. The computer-implemented method of claim 1 wherein:
the first video or image data corresponds to the pursued object, and
the analytics is configured to determine a change in mobility potential of the pursued object.

9. The computer-implemented method of claim 1 wherein:
the first video or image data corresponds to the pursued object, and
the analytics is configured to determine, based on a change in a behavior of the pursued object, a change in: i) threat level to the pursuer object, or ii) a change in expected visibility of the pursued object.

10. The computer-implemented method of claim 9 further comprising automatically generating, on the mobile electronic device, an audibly or visibly perceivable alert corresponding to the determined change.

11. A system comprising:
at least one processor;
at least one fixed-location camera configured to capture video or image data; and
at least one electronic storage medium storing program instructions that when executed by the at least one processor cause the at least one processor to perform:
tracking a pursuer object and a pursued object, wherein the pursuer object is engaged in movement consistent with potentially entering a Field Of View (FOV) of the at least one fixed-location camera at a future point in time;
analyzing additional video or image data corresponding to at least one of the pursuer object and the pursued object to determine at least one pursuit-context detail;
matching the at least one pursuit-context detail to a select one of a plurality of object behavior-targeted analytics;
after the one of the plurality of object behavior-targeted analytics is selected, actuating the one of the plurality of object behavior-targeted analytics to act on the video or image data captured by the at least one fixed-location camera in generating information relevant to a potential pursuer confrontation or apprehension in relation to the pursued object; and
making the generated information electronically accessible to a mobile electronic device prior to the potential pursuer confrontation or apprehension.

12. The system of claim 11 wherein the pursuer object is a police officer and the pursued object is a suspected perpetrator of an offence.

13. The system of claim 11 wherein:
the additional video or image data is video data captured from another fixed-location camera, and
the at least one processor is further caused to perform generating a notification of the pursuer object leaving an FOV of the another fixed-location camera when the pursuer object moves into a defined exit region of the FOV of the another fixed-location camera.

14. The system of claim 11 wherein:
the additional video or image data corresponds to the pursued object, and
the at least one processor is further caused to perform determining a change in mobility potential of the pursued object.

15. The system of claim 11 wherein:
the additional video or image data corresponds to the pursued object, and
the at least one processor is further caused to perform determining, based on a change in a behavior of the pursued object, a change in: i) threat level to the pursuer object, or ii) a change in expected visibility of the pursued object.
